(19) United States
(12) Patent Application Publication
(10) Pub. No.: US 2026/0355638 A1
(43) Pub. Date: Nov. 12, 2026

(54) GAMING SYSTEM AND INFORMATION PROCESSING METHOD

(71) Applicant: Sony Group Corporation, Tokyo (JP)

(72) Inventor: Justinas MISEIKIS, Stuttgart (DE)

(73) Assignee: Sony Group Corporation, Tokyo (JP)

(21) Appl. No.: 19/134,752

(22) PCT Filed: Dec. 8, 2023
(86) PCT No.: PCT/EP2023/084931

§ 371 Date: Jun. 2, 2025

(30) Foreign Application Priority Data
Dec. 9, 2022 (EP) 22212580.9

(51) Int. Cl. A63F 13/79; A63F 13/77

(52) U.S. Cl. CPC A63F 13/79; A63F 13/77

(57) ABSTRACT

A gaming system, wherein the gaming system includes: a user operation device configured to acquire a user operation from a user associated with a user profile; a biometric data acquisition device configured to acquire, in response to a predetermined user operation, biometric data of the user; and a user profile management system configured to: run a gaming application using one of a plurality of user profiles, switch, in response to an obtained indication which indicates that the acquired biometric data match target biometric data of the user associated with the user profile, to the user profile of the user for the gaming application.

### TECHNICAL FIELD

The present disclosure generally pertains to a gaming system and an information processing method.

### TECHNICAL BACKGROUND

Many gaming consoles support different user profiles and have a user profile for each of multiple players. These are typically selected when turning on the console, so the favorite games, point tracking and other aspects related to gaming can be synchronized to the specific player.

However, switching of user profiles may be, in some cases, a cumbersome process, for example, as a player might need to get back to the main menu, which may require pausing or stopping the game and spending some time in the switching process. This may result in some players ignoring it, especially when it comes to more than one player using the gaming console, for example, during a party when more people than gaming controllers are present.

Although there exist techniques for switching user profiles in a gaming system, it is generally desirable to improve the existing techniques.

### SUMMARY

According to a first aspect the disclosure provides a gaming system, comprising:
a user operation device configured to acquire a user operation from a user associated with a user profile;
a biometric data acquisition device configured to acquire, in response to a predetermined user operation, biometric data of the user; and
a user profile management system configured to:
   run a gaming application using one of a plurality of user profiles,
   switch, in response to an obtained indication which indicates that the acquired biometric data match target biometric data of the user associated with the user profile, to the user profile of the user for the gaming application.

According to a second aspect the disclosure provides an information processing method for a gaming system, comprising:
acquiring a user operation from a user associated with a user profile;
acquiring, in response to a predetermined user operation, biometric data of the user;
running a gaming application using one of a plurality of user profiles; and
switching, in response to an obtained indication which indicates that the acquired biometric data match target biometric data of the user associated with the user profile, to the user profile of the user for the gaming application.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates in a block diagram an embodiment of a gaming system;

FIG. 2 schematically illustrates in a flow diagram an embodiment of an information processing method;

FIG. 3 schematically illustrates in a block diagram an embodiment of a gaming system; and

FIG. 4 schematically illustrates in a flow diagram an embodiment of an information processing method.

### DETAILED DESCRIPTION OF EMBODIMENTS

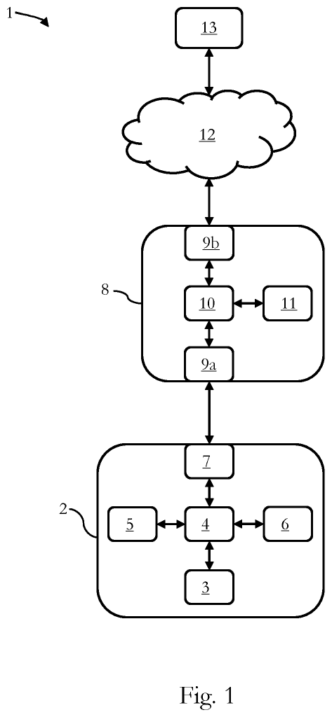

Before a detailed description of the embodiments under reference of FIG. 1 is given, general explanations are made.

As mentioned in the outset, many gaming consoles support different user profiles and have a user profile for each of multiple players. These are typically selected when turning on the console, so the favorite games, point tracking and other aspects related to gaming can be synchronized to the specific player.

However, it has been recognized that switching of user profiles may be, in some cases, a cumbersome process, for example, as a player might need to get back to the main menu, which may require pausing or stopping the game and spending some time in the switching process. This may result in some players ignoring it, especially when it comes to more than one player using the gaming console, for example, during a party when more people than gaming controllers are present.

It has further been recognized that for such a situation a biometric data acquisition device, e.g., a fingerprint scanner may be used or may be embedded into a user operation device such as the gaming controller, a mouse, a keyboard or any other type of user operation device for a gaming application in order to switch the user profile “on the fly”.

In some embodiments, the scanner is located in a convenient physical location on the user operation device, where it is easy to reach for the user/player and optionally combined with a physical button to activate the biometric data acquisition device upon pressing it.

In some embodiments, the finger of the user is placed on the fingerprint scanner, and the fingerprint scanner acquires biometric data of the user's finger to detect a change of a player, and a quick prompt in the game would pop up to ask if the user profile should be changed.

A simple press again, in some embodiments, confirms the switching of the user profile, or otherwise, the pop-up may be ignored. In this way, user profiles may be changed even mid-game if needed.

This approach may allow, in some embodiments, a very quick and efficient way of changing the user profiles and ensures that all the personalization such as custom keys, moves, and all gaming statistics, game progress could be adjusted and may be more precise.

Furthermore, it has been recognized that such user profiles may be shared for online accounts, in some embodiments. In this way, in some embodiments, a user may agree with sharing the user's biometric data with the online user profile/console cloud service, or just with specific friends and their biometric login may work on their synced devices automatically. In some embodiments, the user quickly logs on to the gaming device of a friend or even in the gaming arcade without any additional requirements.

It has further been recognized that with more games being available on the cloud where download might not be necessary, even purchased/accessed games may be adjusted, in some embodiments, upon biometric login of the user and are not tied to a physical gaming device. In this way, in some embodiments, the user may go around cumbersome login procedures, in some cases, dealing with forgotten passwords or risk of forgetting to log out on other gaming devices and leaving their data accidentally exposed on other gaming devices.

Furthermore, in some embodiments, it may allow the user to easily play their purchased games at their friend's places, arcades, offices, or any location where a supported gaming device is located.

It has been recognized that it may further be applied, in some embodiments, for shared mobility and gaming devices likely to be integrated into vehicles for passengers, public transportation, airplanes, and other means of transportation or waiting halls.

In some embodiments, a cloud service and cloud-based gaming may allow a player to use biometric login to access the user's own game library on any supported machine. For example, in some embodiments, the user may go a friend's place and logs on using the user's biometrics (access maybe pre-shared), both may play the games the user has purchased, including multi-player.

Hence, some embodiments pertain to a gaming system, wherein the gaming system includes:
a user operation device configured to acquire a user operation from a user associated with a user profile;
a biometric data acquisition device configured to acquire, in response to a predetermined user operation, biometric data of the user; and
a user profile management system configured to:
   run a gaming application using one of a plurality of user profiles,
   switch, in response to an obtained indication which indicates that the acquired biometric data match target biometric data of the user associated with the user profile, to the user profile of the user for the gaming application.

The user operation device may be or may include a mouse, a keyboard, a gaming controller (which may also be referred to as gamepad), a touch display or a mobile communications device (e.g., a smartphone or a tablet computer) or the like. The user operation device may include user operation elements such as one or more physical buttons, knobs, joysticks, microphones, touch display, acceleration sensors, etc. to receive the user operation from the user.

The biometric data acquisition device may be or may include a fingerprint scanner, a face scanner or an iris scanner or the like. The biometric data acquisition device may include a storage (data storage) and/or a processor for processing data and/or a communications interface for exchanging data with other devices.

The user profile management system may be or may include or may be implemented by a local gaming device (e.g., a gaming console, a portable gaming console, a gaming machine (e.g., in a gaming hall) or a mobile communications device (e.g., a smartphone or a tablet computer)). The local gaming device may include a second user operation device to acquire a second user operation from the user to control a data input to the gaming application.

The second user operation device may be or may include a mouse, a keyboard, a gaming controller (which may also be referred to as gamepad), a touch display or a mobile communications device (e.g., a smartphone or a tablet computer) or the like. The second user operation device may include user operation elements such as one or more physical buttons, knobs, joysticks, microphones, touch display, acceleration sensors, etc. to receive the second user operation from the user.

The user profile management system may be or may include or may be implemented by a remote information processing device (e.g., a server or a computer in a network-based gaming cloud).

The user profile management system may be or may be implemented based on a distributed computing environment and may include a local gaming device and a remote information processing device which complement each other in terms of functions to provide the functions of the user profile management system as described herein.

The user operation may be or may include any type of user interaction via the user operation device such as pressing a button or key, perform a touch operation on a touch screen, an utterance of the user recorded with a microphone, a movement of the user operation device by the user or the like.

The switching of the user profile may be performed in-game (during running the gaming application) or out-of-game (before starting/restarting the gaming application).

In some embodiments, the user operation controls activation of the biometric data acquisition device and/or a data input to the gaming application.

The second user operation may be or may include any type of user interaction via the second user operation device such as pressing a button or key, perform a touch operation on a touch screen, an utterance of the user recorded with a microphone, a movement of the second user operation device by the user or the like to control a data input to the gaming application.

In some embodiments, the second user operation controls a data input to the gaming application.

The biometric data may be or may include raw biometric data or pre-processed raw biometric data such that the biometric data represent biometric features characteristic of a person (e.g., biometric features of a fingerprint, a face or an iris of a person).

The gaming application may be or may include a computer game which may be single-or multi-player or an administrative application for computer games which relies or rely on user profiles.

The user profile may be or may include user profile data representing statistics, achievements, gaming progress, configurations, etc. for one or more gaming applications for a particular user.

The user profile data of one or more user profiles of one or more users, respectively, may be stored on the local gaming machine or may be stored on the remote information processing device.

The user profile data may include data representing computer games that are owned or rented by a particular user.

The target biometric data is the biometric data for the particular user associated with the user profile.

The indication may be or may include or may be based on data that represent an identifier for a particular user profile and one or more bits to indicate that the acquired biometric data match the target biometric data for that particular user.

The user operation device, the second user operation device, the biometric data acquisition device and the user profile management system may communicate with each other, and exchange data based on a wired or wireless connection, wherein the connection may be or may include a device-to-device connection (e.g., Bluetooth®, Wi-Fi®, Near Field Communication (NFC™), etc.) or may be or may include a connection over a network (e.g., the Internet, a mobile telecommunications network, etc.).

Generally, the gaming application may be run on a local gaming device or a remote information processing device.

Hence, in some embodiments, the user profile management system includes a local gaming device configured to run the gaming application.

In some embodiments, the user profile management system includes a remote information processing device configured to run the gaming application.

In some embodiments, the local gaming device includes the user operation device.

In some embodiments, the user operation device includes the biometric data acquisition device.

In some embodiments, the user operation device includes a predetermined button, and the predetermined user operation is a press on the predetermined button for activating the biometric data acquisition device.

The predetermined button may be a physical button or may be a button displayed on a touch screen.

In some embodiments, the user operation device includes the biometric data acquisition device, wherein the biometric data acquisition device is further configured to detect finger presence, and the predetermined user operation is a placement of a finger of the user on the biometric data acquisition device.

In such embodiments, the biometric data acquisition device may be a fingerprint scanner (e.g., similar as in phones) which may be provided either on a side, the back or the front of the user operation device, or it may be provided as an under-screen scanner. For example, the fingerprint scanner detects finger presence and the scanning action is initiated automatically in response thereto without pressing a physical button.

In some embodiments, the user profile management system is configured to request confirmation from the user to switch to the user profile.

In some embodiments, the user operation device is configured to store the target biometric data.

In some embodiments, the user operation device is configured to determine whether the acquired biometric data match the target biometric data for obtaining the indication. In such embodiments, the user operation device is configured to transmit the indication to the user profile management system.

In some embodiments, the user profile management system is configured to store the target biometric data.

In some embodiments, the user profile management system is configured to determine whether the acquired biometric data match the target biometric data for obtaining the indication.

In some embodiments, the user profile management system includes a local gaming device configured to store the target biometric data.

In some embodiments, the local gaming device is configured to determine whether the acquired biometric data match the target biometric data to obtain the indication.

In some embodiments, the local gaming device implements the user profile management system (and thus has all of the functions of the user profile management system as described herein).

In some embodiments, the user profile management system includes a remote information processing device configured to obtain the indication from the local gaming device and to switch the user profile in response to the obtained indication.

In some embodiments, the user profile management system includes a remote information processing device configured to store the target biometric data.

In some embodiments, the remote information processing device is configured to determine whether the acquired biometric data match the target biometric data for obtaining the indication.

Some embodiments pertain to an information processing method for a gaming system, wherein the information processing method includes:
acquiring a user operation from a user associated with a user profile;
acquiring, in response to a predetermined user operation, biometric data of the user;
running a gaming application using one of a plurality of user profiles; and
switching, in response to an obtained indication which indicates that the acquired biometric data match target biometric data of the user associated with the user profile, to the user profile of the user for the gaming application.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

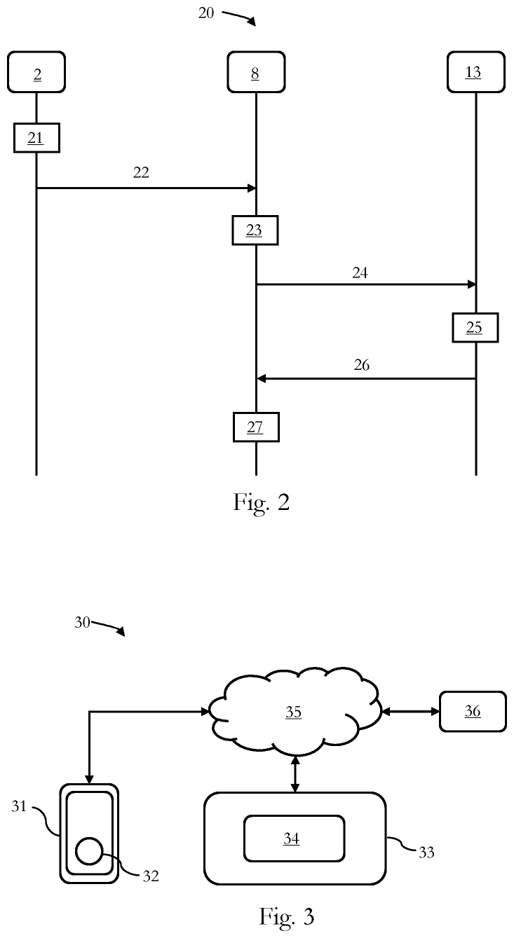

Returning to FIG. 1, there is schematically illustrated in a block diagram an embodiment of a gaming system 1, which will be discussed under reference of FIG. 1 and FIG. 2 in the following.

The gaming system 1 includes a user operation device 2—which is here a gamepad—, a local gaming device 8—which is here a gaming console—and a remote information processing device 13—which is here a server computer.

The user operation device 2 includes user operation elements 3 (e.g., physical buttons, joysticks, touch display, microphone, acceleration sensors, etc.), a processor 4 for processing data, a biometric data acquisition device 5—which is here a fingerprint scanner—, a data storage 6 for storing data representing, e.g., various computer programs executed by the processor 4.

The user operation elements 3 may receive various user operations performed by a user which generates electric signals based which data is generated representing the performed user operation.

The user operations control a data input to a gaming application which runs on the local gaming device 8.

The user operation elements 3 include a predetermined button which, when the predetermined button is pressed, cause the processor 4 to activate the biometric data acquisition device 5 to acquire biometric data of a user. Thus, a predetermined user operation controls activation of the biometric data acquisition device 5.

The user operation device 2 further includes a communication interface 7 for communicating based on a wired (e.g., USB) or wireless (e.g., Bluetooth®) connection with the local gaming machine 8.

The processor 4 transmits data representing the performed user operations and/or including acquired biometric data to the local gaming machine 8 via the communication interface 7.

The local gaming device 8 includes a first communication interface 9a and a second communication interface 9b, a processor 10 for processing data and a data storage 11 for storing data.

The first communication interface 9a communicates with the communication interface 7 of the user operation device 2 to receive data representing the performed user operations on the user operation elements 3 and/or include acquired biometric data of a user.

The processor 10 executes various computer programs stored on the data storage 11, in particular the processor 10 runs a gaming application using a user profile.

The data storage 11 stores various data representing, e.g., the gaming application and including target biometric data of a plurality of users in association with a user profile identifier and including temporary user profile data which is used for the gaming application.

The second communication interface 9b communicates with the remote information processing device 13 over a network 12 (e.g., the Internet).

For example, the processor 10 transmits data indicating changes in the user profile data associated with a user profile used in the gaming application to the remote information processing device 13 for storage, wherein the data represent changes in statistics, achievements, gaming progress, configurations, etc.

The local gaming device 8 is further coupled to a display device (not shown in FIG. 1) and the processor 10 outputs audio and video content in accordance with the gaming application to the display device via, e.g., the first and/or second communication interface 9a and 9b for outputting the content to the user(s).

The local gaming device 8 together with the remote information processing device 13 forms a user profile management system.

An embodiment of an information processing method 20 is shown in FIG. 2 which is discussed under reference of FIG. 1 and FIG. 2 in the following.

It is assumed that the local gaming device 8 (the local gaming console) is present at location A of user A and user B is at location A for playing computer games together with user A (not shown in FIG. 1).

The user A has stored the user's A fingerprint, the user's A target biometric data, in advance on the data storage 11 of the local gaming machine 8 in association with a user profile identifier which uniquely identifies a user profile A associated with the user A.

The user B has stored the user's B fingerprint, the user's B target biometric data, in advance on the data storage 11 of the local gaming machine 8 in association with a user profile identifier which uniquely identifies a user profile B associated with the user B.

At first, the processor 10 runs the gaming application using user profile A while user A is playing.

Then, the user B wishes to play, and user A does not want to let user B play with the user's A user profile A.

Thus, at 21, the user B holding the user operation device 2 (the gamepad) presses the predetermined button among the user operation elements 3 such that the biometric data acquisition device 5 (the fingerprint scanner) is activated.

The user B places the finger on the biometric data acquisition device 5, which then acquires biometric data of the user B.

At 22, the processor 4 transmits the acquired biometric data and data representing the predetermined user operation, which indicates initiation of a switch of the user profile, to the local gaming device 8 via the communication interface 7.

The local gaming device 8 obtains the acquired biometric data and the data representing the predetermined user operation via the first communication interface 9a.

Then, at 23, the processor 10 compares the acquired biometric data with target biometric data of a plurality of users including the user A and the user B until a match is determined or not.

The processor 10 determines that the acquired biometric data match the target biometric data of the user B.

Then, at 24, the processor 10 transmits an indication to the remote information processing device 13 via the second communication interface 9b and the network 12, wherein the indication includes the user profile identifier for user profile B and one or more bits to indicate that the acquired biometric data match the target biometric data for the user B identified by the user profile identifier.

At 25, the remote information processing device 13 saves all changes to the user profile data associated with the user profile A and loads the user profile data associated with the user profile B for transmission.

At 26, the remote information processing device 13 transmits, in response to the indication, the user profile data associated with user profile B to the local gaming device 8 (via the network 12 and the second communication interface 9b)

At 27, the processor 10 stores the received user profile data associated with user profile B in the data storage 11. Moreover, the processor 10 switches the user profile for the gaming application to the user profile B from the user profile A previously used.

Before the switching of the user profile, the local gaming device 8 may request confirmation from the user B to switch to the user profile B, e.g., via the display device and the user B may press a certain button on the user operation device 2 to confirm.

In other embodiments, the remote information processing device 13 runs the gaming application and the local gaming device 8 acts basically as an access point to the gaming application. In such embodiments, the switching of the user profile is performed on the remote information processing device 13 in response to the indication from the local gaming device 8. Moreover, in such embodiments, the data representing user operations is transmitted to the remote information processing device 13 via the local gaming device 8 for input to the gaming application.

FIG. 3 schematically illustrates in a block diagram an embodiment of a gaming system 30, which will be discussed under reference of FIG. 3 in the following.

In this embodiment, the gaming system 30 includes a first user operation device 31—which is a smartphone here—and which includes a biometric data acquisition device 32—a fingerprint scanner.

The gaming system 30 further includes a local gaming device 33—which is a gaming machine in a gaming hall here—and which includes a second user operation device 34.

The gaming system 30 further includes a remote information processing device 36 which can communicate with the first user operation device 31 and with the local gaming machine 33 via a network 35.

It is assumed in the following that a user C wishes to play a computer game supported by the local gaming machine 33 in the gaming hall as an access point.

The gaming application runs on the remote information processing device 36 and requires biometric login for switching the user profile from a default user profile to a personalized user profile C associated with the user C.

The user C runs an app on the smartphone 31 which lists several gaming machines in the gaming hall and the user C selects with a touch from that list the specific local gaming machine 33.

Then, as the user C has performed a predetermined user operation on the user operation device 31, the smartphone 31 activates the fingerprint scanner 32 and acquires biometric data of the user C.

Then, the smartphone 31 compares the acquired biometric data with target biometric data stored on the smartphone 31.

When they match, the smartphone 31 transmits, via the network 35, an indication to the remote information processing device 36 (network destination may be obtained from the app by selecting the particular gaming machine from the list), wherein the indication includes a user profile identifier for user profile C associated with the user C and one or more bits to indicate that the acquired biometric data match the target biometric data for the user C identified by the user profile identifier.

Then, the remote information processing device 36 switches the user profile for the gaming application to the user profile C in response to the indication from the smartphone 31.

The user C may be required to confirm the switching via the second user operation device 34 in the local gaming machine 33.

Then, the user C can play the game via the local gaming machine 33 by performing user operations on the second user operation device 34 to control a data input to the gaming application.

The user C may be required to regularly confirm usage of the user profile C on the first user operation device 31 (the smartphone) to avoid usage of the user profile C by an unallowed person via the local gaming machine 33 (e.g., when the user C leaves without logging out).

Moreover, the remote information processing device 36 may analyze user operation patterns for the particular gaming application (e.g., frequency of pressing buttons, typical movements, etc.) associated with the user profile C and may request confirmation on the smartphone 31 when the user operations deviate from the typical user operation pattern indicating a different player than the user C.

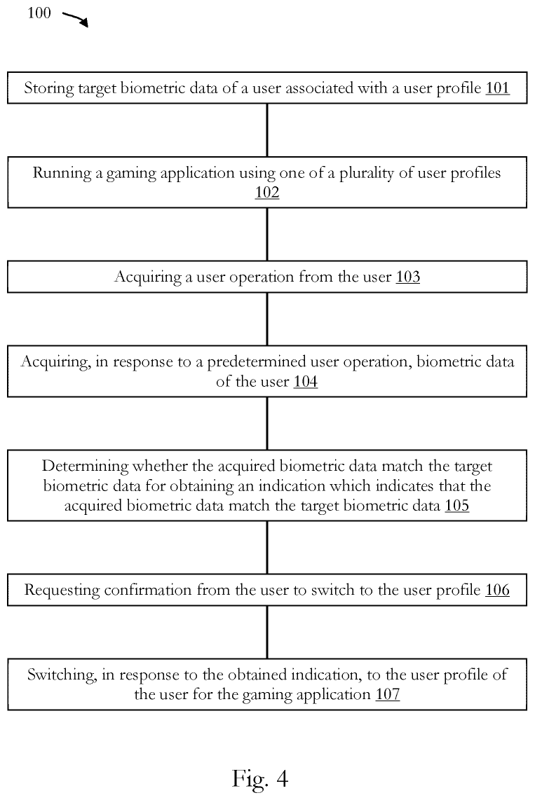

FIG. 4 schematically illustrates in a flow diagram an embodiment of an information processing method 100.

The information processing method 100 may be performed by the gaming system 1 of FIG. 1 or the gaming system 30 of FIG. 30, for example, or by any gaming system as described herein.

At 101, target biometric data of a user associated with a user profile is stored, as discussed herein.

At 102, a gaming application is run using one of a plurality of user profiles, as discussed herein.

At 103, a user operation is acquired from the user, as discussed herein.

At 104, in response to a predetermined user operation, biometric data of the user is acquired, as discussed herein.

At 105, it is determined whether the acquired biometric data match the target biometric data for obtaining an indication which indicates that the acquired biometric data match the target biometric data, as discussed herein.

At 106, confirmation from the user to switch to the user profile is requested, as discussed herein.

At 107, in response to the obtained indication, it is switched to the user profile of the user for the gaming application, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A gaming system, wherein the gaming system includes:
a user operation device configured to acquire a user operation from a user associated with a user profile;
a biometric data acquisition device configured to acquire, in response to a predetermined user operation, biometric data of the user; and a user profile management system configured to:
   run a gaming application using one of a plurality of user profiles,
   switch, in response to an obtained indication which indicates that the acquired biometric data match target biometric data of the user associated with the user profile, to the user profile of the user for the gaming application.

(2) The gaming system of (1), wherein the user profile management system is configured to store the target biometric data.

(3) The gaming system of (2), wherein the user profile management system is configured to determine whether the acquired biometric data match the target biometric data for obtaining the indication.

(4) The gaming system of anyone of (1) to (3), wherein the user operation device includes a predetermined button, and the predetermined user operation is a press on the predetermined button for activating the biometric data acquisition device; or
wherein the user operation device includes the biometric data acquisition device, wherein the biometric data acquisition device is further configured to detect finger presence, and the predetermined user operation is a placement of a finger of the user on the biometric data acquisition device.

(5) The gaming system of anyone of (1) to (4), wherein the user profile management system is configured to request confirmation from the user to switch to the user profile.

(6) The gaming system of anyone of (1) to (5), wherein the user operation device includes the biometric data acquisition device.

(7) The gaming system of anyone of (2) to (6), wherein the user profile management system includes a local gaming device configured to store the target biometric data.

(8) The gaming system of (7), wherein the local gaming device is configured to determine whether the acquired biometric data match the target biometric data to obtain the indication.

(9) The gaming system of (8), wherein the local gaming device implements the user profile management system.

(10) The gaming system of (8), wherein the user profile management system includes a remote information processing device configured to obtain the indication from the local gaming device and to switch the user profile in response to the obtained indication.

(11) The gaming system of anyone of (2) to (6), wherein the user profile management system includes a remote information processing device configured to store the target biometric data.

(12) The gaming system of (11), wherein the remote information processing device is configured to determine whether the acquired biometric data match the target biometric data for obtaining the indication.

(13) The gaming system of anyone of (1) to (12), wherein the user profile management system includes a local gaming device configured to run the gaming application.

(14) The gaming system of (13), wherein the local gaming device includes the user operation device.

(15) The gaming system of anyone of (1) to (12), wherein the user profile management system includes a remote information processing device configured to run the gaming application.

(16) An information processing method for a gaming system, wherein the information processing method includes:
acquiring a user operation from a user associated with a user profile;
acquiring, in response to a predetermined user operation, biometric data of the user;
running a gaming application using one of a plurality of user profiles; and
switching, in response to an obtained indication which indicates that the acquired biometric data match target biometric data of the user associated with the user profile, to the user profile of the user for the gaming application.

(17) The information processing method of (16), including storing the target biometric data.

(18) The information processing method of (16) or (17), including determining whether the acquired biometric data match the target biometric data for obtaining the indication.

(19) The information processing method of anyone of (16) to (18), wherein the predetermined user operation is a press on a predetermined button, or wherein the predetermined user operation is a placement of a finger of the user on a biometric data acquisition device.

(20) The information processing method of anyone of (16) to (19), including requesting confirmation from the user to switch to the user profile.

(21) A computer program comprising program code causing a computer to perform the method according to anyone of (16) to (20), when being carried out on a computer.

(22) A non-transitory computer-readable recording medium that stores therein a computer program product, which, when executed by a processor, causes the method according to anyone of (16) to (20) to be performed.

1. A gaming system, comprising:
a user operation device configured to acquire a user operation from a user associated with a user profile;
a biometric data acquisition device configured to acquire, in response to a predetermined user operation, biometric data of the user; and
a user profile management system configured to:
run a gaming application using one of a plurality of user profiles,
switch, in response to an obtained indication which indicates that the acquired biometric data match target biometric data of the user associated with the user profile, to the user profile of the user for the gaming application.

2. The gaming system according to claim 1, wherein the user profile management system is configured to store the target biometric data.

3. The gaming system according to claim 2, wherein the user profile management system is configured to determine whether the acquired biometric data match the target biometric data for obtaining the indication.

4. The gaming system according to claim 1, wherein the user operation device includes a predetermined button, and the predetermined user operation is a press on the predetermined button for activating the biometric data acquisition device; or
wherein the user operation device includes the biometric data acquisition device, wherein the biometric data acquisition device is further configured to detect finger presence, and the predetermined user operation is a placement of a finger of the user on the biometric data acquisition device.

5. The gaming system according to claim 1, wherein the user profile management system is configured to request confirmation from the user to switch to the user profile.

6. The gaming system according to claim 1, wherein the user operation device includes the biometric data acquisition device.

7. The gaming system according to claim 2, wherein the user profile management system includes a local gaming device configured to store the target biometric data.

8. The gaming system according to claim 7, wherein the local gaming device is configured to determine whether the acquired biometric data match the target biometric data to obtain the indication.

9. The gaming system according to claim 8, wherein the local gaming device implements the user profile management system.

10. The gaming system according to claim 8, wherein the user profile management system includes a remote information processing device configured to obtain the indication from the local gaming device and to switch the user profile in response to the obtained indication.

11. The gaming system according to claim 2, wherein the user profile management system includes a remote information processing device configured to store the target biometric data.

12. The gaming system according to claim 11, wherein the remote information processing device is configured to determine whether the acquired biometric data match the target biometric data for obtaining the indication.

13. The gaming system according to claim 1, wherein the user profile management system includes a local gaming device configured to run the gaming application.

14. The gaming system according to claim 13, wherein the local gaming device includes the user operation device.

15. The gaming system according to claim 1, wherein the user profile management system includes a remote information processing device configured to run the gaming application.

16. An information processing method for a gaming system, comprising:
acquiring a user operation from a user associated with a user profile;
acquiring, in response to a predetermined user operation, biometric data of the user;
running a gaming application using one of a plurality of user profiles; and
switching, in response to an obtained indication which indicates that the acquired biometric data match target biometric data of the user associated with the user profile, to the user profile of the user for the gaming application.

17. The information processing method according to claim 16, comprising storing the target biometric data.

18. The information processing method according to claim 16, comprising determining whether the acquired biometric data match the target biometric data for obtaining the indication.

19. The information processing method according to claim 16, wherein the predetermined user operation is a press on a predetermined button, or wherein the predetermined user operation is a placement of a finger of the user on a biometric data acquisition device.

20. The information processing method according to claim 16, comprising requesting confirmation from the user to switch to the user profile.
